(19) United States
(12) Patent Application Publication
(10) Pub. No.: US 2009/0136885 A1
(43) Pub. Date: May 28, 2009

(54) APPARATUS FOR TOASTING A WINE BARREL

(75) Inventor: Pal Manno, Pecs (HU)

Correspondence Address: Edwards Angell Palmer & Dodge LLP, 350 East Las Olas Boulevard, Fort Lauderdale, FL, 33301, US

(73) Assignee: Mirage Business Capital Inc., West Palm Beach, FL (US)

(21) Appl. No.: 11/944,927

(22) Filed: Nov. 26, 2007

(51) Int. Cl. F27B 21/00; F27D 19/00

(52) U.S. Cl. 432/37; 432/11; 432/232; 432/32

(57) ABSTRACT

A platform has an opening therein. The platform is adapted to receive a heat source therein. The platform is rotatably disposed about the heat source. A motor is operatively coupled to the platform for rotating the platform about the heat source. A temperature sensor senses the temperature at a predetermined position on the interior surface of a barrel disposed on said platform and provides a temperature output. A central processing unit has a clock for measuring an interval during which a barrel is exposed to the heat source. A database stores toasting recipes, which are a function of time and temperature. The central processing unit receives an input from the sensor and clock and utilizes the recipe stored in the database to provide an output to an alarm if the sensed temperature during the input time interval does not substantially correspond the recipe as stored in the database.

### BACKGROUND OF THE INVENTION

The invention is directed to the manufacture of wine barrels, and in particular, an apparatus, which provides for consistency in toasting wine barrels.

For centuries, coopers have made barrels for wine. The barrels are prepared by toasting. Toasting is the exposure of the barrel to temperature over time to change the “flavor” of the barrel. There are “recipes” for toasting which will change the amount and type of flavor that a barrel will add to the wine.

For centuries, toasting was accomplished by building a fire usually contained in a firepot. This firepot created a controlled open flame. An uncapped barrel was manually placed about the firepot. The barrel would be periodically manually rotated about the flame and flipped over to provide consistency in toasting across the barrel interior. Rotation occurred by the cooper giving the barrel a partial turn about the firepot. When rotation was to occur was determined by elapsed time, but more importantly by the skill of the cooper who would also determine the appropriate time to rotate, flip or remove the barrel as a function of the smell, temperature and appearance of the barrel.

This methodology was sufficient for centuries, but relies heavily upon the skill of a few master coopers. Therefore, even from the same cooperage, the desired toasting can change from barrel to barrel even if given the same recipe. The toast of a barrel can change with time exposure to the flame, distance to the flame, and even the temperature of the flame. The toast can change with rotation timing, rotation consistency and rotation distance. It follows that toasting can change as a function of the skill set of the individual artisan controlling the toasting process, the health of the cooper as it affects their sense of scent and sight and numerous other variables. Therefore, inconsistency could result across a product line even for the same cooper. There may be inconsistencies between master coopers in a single cooperage. This issue is compounded in that different vineyards want different toasting flavors for their respective barrels (i.e. different recipes).

Furthermore, not only is it difficult to replicate results even with the same facilities and same coopers, but the cooperage and customers are now beholden to a master cooper not leaving or retiring. Even if the master cooper trains a successor, the successor may not perform in the exact same manner. To overcome these deficiencies, some coopers rely upon outside temperature sensors to measure the external temperature of the barrel to indicate to a cooper when to rotate, remove or flip the barrel. However, the process still relies on the judgment of the cooper and does not account for uneven placement of the barrel relative to the open flame or distraction of the cooper from the sensors, which may result in an inaccurate temperature measurement, or the cooper's failure to properly monitor the time interval.

Accordingly, an apparatus for toasting barrels, which overcomes the shortcomings of the prior art, is desired.

### BRIEF SUMMARY OF THE INVENTION

An apparatus, includes a heat source. A rotatable platform is disposed about the heat source. A positioning member is disposed on a surface of the rotatable platform and is adapted to engage with a barrel when the barrel is disposed on the rotatable platform to position a barrel on the rotatable platform. A motor is operatively connected to the rotatable platform for rotating the platform about the heat source at a substantially constant speed.

In a preferred embodiment, a database stores a library of toasting recipes. The recipes include a time component and a temperature component. In one embodiment, the temperature component includes temperatures at predetermined time intervals. A computer or central processing unit (CPU) is coupled to the database. A clock corresponding to a time period during which the toasting process occurs provides a clock input to the CPU. A temperature sensor senses a temperature at a predetermined position of the interior of a barrel disposed on the rotatable platform. The sensor provides an input to the CPU. The processor, at predetermined intervals, compares the sensed temperature and the time interval to the desired recipe when the temperature and time interval correspond to that in the desired recipe, the CPU signals a cooper regarding the next action, whether it be a change in the temperature, a flipping of the barrel, or removal of the barrel.

### BRIEF DESCRIPTION OF THE DRAWINGS

For a fuller understanding of the invention, reference is had to the following description taken in connection with the accompanying drawings in which:

FIG. 1 is a top plan view of the apparatus constructed in accordance with the invention;

FIG. 2 is a side sectional view along line 1-1 of FIG. 1; and

FIG. 3 is a schematic drawing of an apparatus in accordance with a second embodiment of the invention including a temperature sensor for controlling the operation of the apparatus in accordance with the invention.

### DETAILED DESCRIPTION OF THE INVENTION

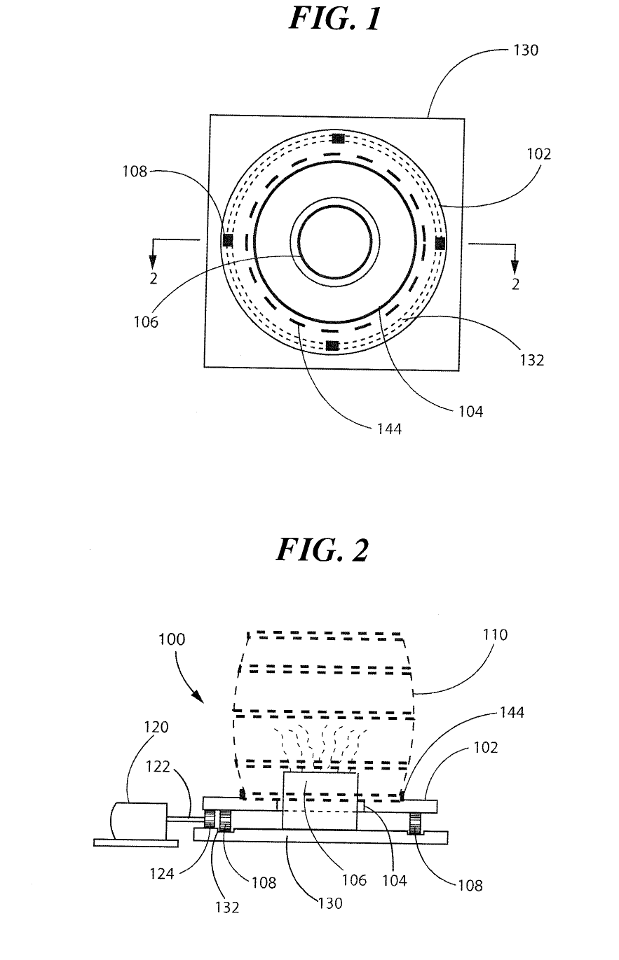

Reference is made to FIG. 1 in which an apparatus, generally indicated as 100, for toasting a wooden barrel is provided. We note that the example below is directed to a method particularly directed to the toasting of oak wine barrels. However, the technique may be utilized for other wooden barrels of other uses such as those made for aging hard spirits (whisky, scotch or the like), and therefore the invention is not limited to toasting oak wine barrels.

Apparatus 100 includes a platform 102 having a central opening 104. Opening 104 is dimensioned and adapted to fit about a heat source such as a firepot 106, open flame, radiator or the like. Preferably, platform 102 is made from a relatively non-heat conductive material. The temperature of platform 102 does not rise sufficiently as a result of exposure to firepot 106 preventing the platform from providing additional toasting to any wood in contact with or adjacent to platform 102. In a preferred embodiment, such material may be one of a ceramic, stone, slate, certain hard plastics or the like.

Reference is now made to FIG. 2 where a sectional view of apparatus 100 shows other features of the device. Wheels 108 extend from and support platform 102 about firepot 106. In this way, firepot 106 extends through opening 104 so that platform 102 may be rotated about firepot 106. In the preferred embodiment, opening 104 is concentric with a center axis of firepot 106 to aid in maintaining an interior circumference of opening 104 and, more importantly, a barrel 110 equidistant from firepot 106 as it rotates about a center axis of firepot 16. In a non-preferred embodiment, opening 104 need not be symmetrical or perfectly formed, so long as firepot 106 extends therethrough and barrel 110 situated on platform 102 has an interior 112 which maintains a substantially constant distance from the center of firepot 106.

A motor 120 has a driveshaft 122 operatively coupled to platform 102. In a preferred embodiment, a drive wheel 124 engages platform 102 and through friction moves the platform to rotate platform 102. It should be noted that a drive wheel relying on friction to rotate is shown as a simple embodiment. However, other drive mechanisms as known in the art, such as a gearing wheel cooperating with a gear track, or a belt drive about platform 102 driven by a motor 120 may be substituted.

In a preferred embodiment, a support 130 such as a floor or platform may include a track or groove 132 formed therein for guiding wheels 108 along a path about firepot 106. Preferably, motor 120 is capable of operating at a plurality of speeds but maintains a single selected speed during operation. In this way, platform 102 rotates uniformly about firepot 106 to account for any irregularities of exposure resulting from an open flame, i.e., each plank of barrel 110 is exposed to firepot 106 from each position about firepot 106 in an equal amount to better compensate for the inconsistency of an open flame.

In a preferred embodiment, as shown in the drawings, platform 102 is a circular disk. This is done for efficiencies in weight, sizing and “eyeballing” placement of barrel 110 relative to the travel of the platform. By making platform 102 circular, barrel 110 can be placed so as to be coaxial with the firepot, which in a preferred embodiment, is coaxial and equidistant about the circumference of opening 104 and equidistant from the outer edge of platform 102; all three aiding in the coaxial placement of barrel 110. However, rather than again relying on the expertise and precision of the cooper across shifts, or even from barrel to barrel, guides 144 are disposed on barrel 102 and are adapted to engage the edge of barrel 110 and hold it at a predetermined position, coaxial and equidistant from firepot 106. Guides 144 may take the form of a plurality of circular grooves for receiving an edge of the barrel therein, or more preferable, detents or bumps extending from platform 102 at a fixed circumference from the center axis of platform 102 to catch an interior or exterior surface of the barrel and maintain it in place about firepot 106.

It should be noted that apparatus 100 maintains consistency in fire exposure by standardizing the exposure of the interior of the barrel to heat over time. Therefore, the consistency of the toasting of the barrel in an identical manner from barrel to barrel over a long period of time is increased. Although consistency is now provided for placement of the barrel and exposure of the barrel to the flame over time, the apparatus described above still relies on the expertise and “nose” of the cooper to know when to remove the barrel and when to flip the barrel. Expertise is no longer required on how to place the barrel or when to rotate the barrel about the flame, but flipping and removal may still be practiced in an inconsistent manner.

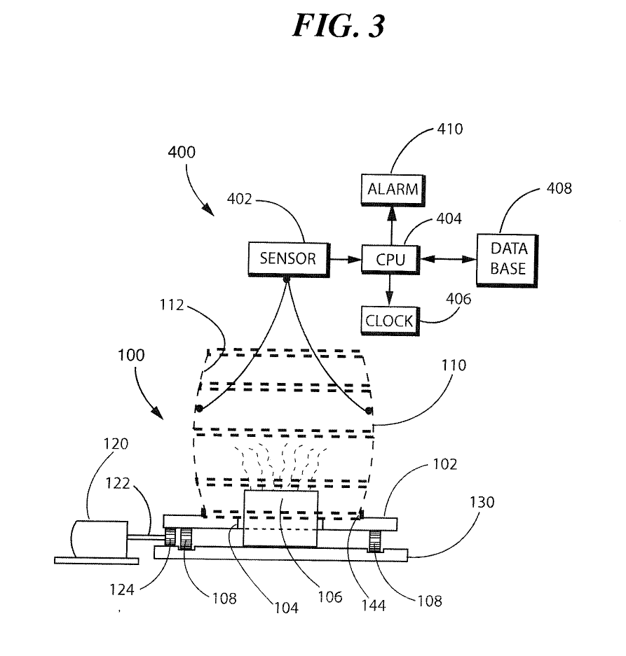

Reference is now made to FIG. 3 where an apparatus, which notifies a cooper when to flip or remove the barrel in accordance with the recipes to increase the precision and accuracy of barrel toasting, is provided. System 400 includes apparatus 100 as described above. A sensor 402 for sensing the temperature at a predetermined position within the interior 112 of a barrel 110 when barrel 110 is placed on platform 102 provides an output to a central processing unit 404. Central processing unit 404 also receives a clock input from a clock 406 for measuring time intervals. Central processing unit 404 communicates with a database 408 to receive toasting operation instructions utilizing stored time and temperature data associated with recipes.

Database 408 includes a library of toasting “recipes” which map known toasting effects to temperature exposure over intervals of time. These may be stored as an operative function in which the function of determining toasting is a function of changing time of exposure and changing temperature. It may be formed as a lookup table mapping known times to known temperatures.

CPU 404 determines time intervals within the toasting process as a function of the clock input. The current temperature during the process is input by sensor 402. Making use of database 408, CPU 404 determines the sensed temperature within barrel 112 during the calculated time interval and compares measured time and temperature to the recipe values stored in database 408 to determine whether or not the recipe is within a tolerable range; an insubstantial deviation. As a result, instructions or an alert may be output to an alarm 410 for corrective action if the time or temperature varies beyond allowable tolerances.

Alarm 410 received an output from central processing unit 404 to trigger an alarm to the cooper that the sensed temperature for the current time interval has deviated beyond a tolerable amount from the stored recipe indicating to the cooper either to increase the temperature, increase the time interval or remove the barrel. In a preferred embodiment, a corrective action such as a temperature or a time interval change may be displayed as determined by central processing unit 404. A different type of alarm such as a change signal may be given when the recipe has been completed, i.e, the time/temperature curve to a particular requested toasting recipe has been performed. The cooper will then know whether to remove or flip the barrel.

In a preferred embodiment, sensor 402 is a laser-based temperature sensor, which outputs a laser at predetermined points on the interior 112 of the barrel 110. In a preferred non-limiting embodiment, the laser is aimed at a particular height of an interior wall 112 of barrel 110. As barrel 110 rotates, sensor 402 is in effect sampling an infinite number of positions along the interior of the wall so as to receive a representative sampling of the temperature at a position at the interior of barrel 110.

In a preferred embodiment, motor 120 is provided with a brake to stop the platform from rotating to allow easy removal and flipping of the barrel by the cooper.

It should be noted that the invention is directed to a system, which automates and standardizes the positioning and exposure of a barrel to the open flame of the firepot during the toasting process. It should also be noted that although many of the structures are adapted to cooperate with a barrel and firepot, neither is part of the invention in its most generic sense. By standardizing the exposure of the barrel to the firepot, reliance on the skill and “nose” of a singular cooper is no longer necessary.

Furthermore, although exemplary and preferred aspects and embodiments of the present invention have been described with a full set of features, it is to be understood that the disclosed apparatus may be practiced successfully without the incorporation of each of those features. Thus, it is to be further understood that modifications and variations may be utilized without departure from the spirit and scope of the invention as those skilled in the art will readily understand. Such modifications and variations are considered to be within the purview of the appended claims and their equivalents.

What is claimed as new and desired to be protected by Letters Patent of the United States is:

1. An apparatus for toasting a barrel comprising:
a platform having an opening therein, the opening being adapted to receive a heat source therethrough, the platform being rotatably disposed about the heat source; and
a motor operatively connected to the platform for rotating said platform about said heat source at a substantially constant speed.

2. The platform of claim 1, further comprising said heat source, said heat source being a firepot extending through the opening.

3. The apparatus of claim 1, further comprising a guide disposed on a surface of the platform adapted to position a barrel on the platform about the opening, coaxial with the heat source.

4. The apparatus of claim 3, wherein said at least one guide is a groove formed within the platform.

5. The apparatus of claim 3, wherein the guide includes a plurality of detent extending from said platform.

6. The apparatus of claim 1, further comprising wheels rotatably supporting the platform about the heat source.

7. The apparatus of claim 1, further comprising:
a central processing unit;
a temperature sensor for sensing the temperature at a predetermined position an interior of a barrel disposed on said platform and providing a temperature output;
a clock outputting a clock signal corresponding to an interval during which a barrel is exposed to the heat;
a database storing toasting recipes, the toasting recipes being a function of time and temperature;
an alarm, the central processing unit receiving a temperature input from the sensor and the clock signal from the clock, determining a current interval and utilizing the recipe stored in the database to provide an output to the alarm if the sensed temperature during the interval does not substantially correspond to the temperature corresponding to the recipe stored in the database.

8. The platform of claim 7, wherein the alarm indicates at one of increasing the temperature, removing the barrel, reducing the temperature and flipping the barrel.

9. An apparatus for toasting a barrel comprising:
a platform having an opening therein, the opening being adapted to receive a heat source therethrough, the platform being rotatably disposed about the heat source;
a motor operatively connected to the platform for rotating said platform about said heat source at a substantially constant speed, said heat source being a firepot extending through the opening; and
a guide disposed on a surface of the platform adapted to position a barrel on the platform about the opening, coaxial with the heat source, wherein said guide is at least one groove formed within the platform;
the guide member includes a plurality of detent extending from said platform;
wheels rotatably supporting the platform about the heat source;
a central processing unit;
a temperature sensor for sensing the temperature at a predetermined position on the circumference of a barrel disposed on said platform and providing a temperature output;
a clock outputting a clock signal corresponding to an interval during which a barrel is exposed to the heat;
a database storing toasting recipes, the toasting recipes being a function of time and temperature;
an alarm, the central processing unit receiving a temperature input from the sensor and the clock signal from the clock, determining a current interval, and utilizing the recipe stored in the database to provide an output to the alarm if the sensed temperature during the interval does not substantially correspond the temperature corresponding to the recipe stored in the database; and
an alarm indicates at one of increasing the temperature, removing the barrel, reducing the temperature and flipping the barrel.
